(19) United States
(12) Patent Application Publication
(10) Pub. No.: US 2015/0313790 A1
(43) Pub. Date: Nov. 5, 2015

(54) MASSAGE MACHINE

(71) Applicant: Family Inada Co., Ltd., Osaka (JP)

(72) Inventors: Nichimu Inada, Osaka (JP); Mitsuki Kato, Tottori (JP); Mitsunori Tago, Tottori (JP)

(21) Appl. No.: 14/696,115

(22) Filed: Apr. 24, 2015

(30) Foreign Application Priority Data
May 1, 2014 (JP) 2014-094732

(51) Int. Cl. A61H 15/00

(52) U.S. Cl. CPC A61H 15/0078; A61H 2201/1215; A61H 2201/1418; A61H 2201/1671

(57) ABSTRACT

A massage machine includes: a massage mechanism that includes a motor; a drive shaft configured to be driven and rotated by the motor; a pair of treatment members that include a pair of arms supported by the drive shaft and is moved closer to and further from each other by the rotation of the drive shaft; air cells which are provided on inner side surfaces of the arms, the air cells expand and contract in accordance with air supply and air discharge; and press treated portions arranged so as to face each other. The massage machine further includes an air unit that supplies and discharge air to and from the air cells and a control unit that controls the motor and the air unit.

### TECHNICAL FIELD

The present invention relates to a massage machine.

### BACKGROUND ART

In the related art, a chair-type massage apparatus configured to perform massage while pinching thighs from right and left sides with a thigh pinching mechanism provided in a seat portion is known. The massage apparatus is configured such that a pair of massaging bodies is supported at a rotation shaft via a rotation cam which are inclined in mutually opposite directions and kneading massage is performed on the thighs by driving a motor to rotate the rotation shaft and moving the pair of massage bodies closer to and further from each other (see FIG. 1 in JP-A-2004-321318, for example)

### RELATED ART DOCUMENT

### Summary of the Invention

According to the present invention, there is provided a massage machine including: a massage mechanism that includes a motor, a drive shaft configured to be driven and rotated by the motor, and a pair of treatment members configured to include a pair of arms which is supported by the drive shaft and is moved closer to and further from each other by the rotation of the drive shaft and air cells which are provided on inner side surfaces of the arms, which expand and contract in accordance with air supply and air discharge, and press treated portions, which are configured to be arranged so as to face each other with the treated portions pinched therebetween; an air unit configured to supply the air to the air cells and discharge the air from the air cells; and a control unit configured to control driving of the motor and the air unit.

With such a configuration, it is possible to perform a mechanical kneading operation of moving the pair of treatment members closer to and further from each other by the motor and an air kneading operation of causing the air cells to expand and contract by the air unit in an independent manner or a composite manner and to thereby perform various kinds of massage. In addition, it is possible to change an interval between the pair of treatment members by causing the air cells to expand and contract and to thereby perform massage which can satisfy users with different body shapes.

In this case, it is preferable that the massage machine further includes a seat portion on which a user is seated and that the massage mechanism is provided in the seat portion to massage buttocks or thighs as the treated portions.

With such a configuration, it is possible to perform satisfactory massage on buttocks or thighs with significantly different widths which depends on the user.

In addition, it is preferable that the control unit controls the driving of the motor and the air unit so as to cause the air cells to expand and contract while moving the pair of arms closer to and further from each other.

With such a configuration, it is possible to perform the mechanical kneading operation of moving the pair of treatment members closer to or further from each other by the motor and the air kneading operation of causing the air cells to expand and contract by the air unit in the composite manner and to thereby perform various kinds of massage.

Alternatively, the control unit may control the driving of the motor and the air unit so as to move the pair of arms closer to and further from each other in a state in which the air cells are made to expand.

With such a configuration, it is possible to perform a satisfactory mechanical kneading operation regardless of the body shape of the user.

In addition, it is preferable that the control unit is able to adjust an amount of expansion of the air cells by controlling the driving of the air unit.

With such a configuration, it is possible to adjust the strength of the mechanical kneading operation.

In addition, it is preferable that the arms are able to be elastically deformed in directions in which the arms face the treated portions.

With such a configuration, it is possible to prevent the arms from being damaged due to an excessive load.

In addition, it is preferable that the arms include acting portions which act on the treated portions and provide a massage action and coupling portions which are coupled to the drive shaft and that the coupling portions have higher rigidity than that of the acting portions.

With such a configuration, it is possible to prevent an excessive load from being applied to the drive shaft and the motor by the acting portions being elastically deformed and letting reaction force from the treated portions pass aside and by the coupling portions securing rigidity.

According to the present invention, it is possible to perform various kinds of massage and to perform massage which can satisfy users with different body shapes.

### BRIEF DESCRIPTION OF THE DRAWINGS

FIG. 1 is a perspective view of a massage machine according to an embodiment of the present invention.

FIG. 2 is a perspective view of the massage machine, in which inside of a seat portion is exposed.

FIG. 3 is a perspective view of the seat portion and a leg frame.

FIG. 4 is a side view of the seat portion and the leg frame.

FIG. 5 is a plan view of the seat portion and the leg frame.

FIG. 6 is a perspective view of the leg frame.

FIG. 7 is a perspective view of a massage mechanism.

FIG. 8 is a perspective view of the massage mechanism when viewed from another angle.

FIG. 9 is a front view of the massage mechanism.

FIG. 10 is a plan view of a seat portion of a massage machine according to another embodiment of the present invention.

### DESCRIPTION OF THE INVENTION

### Overall Configuration

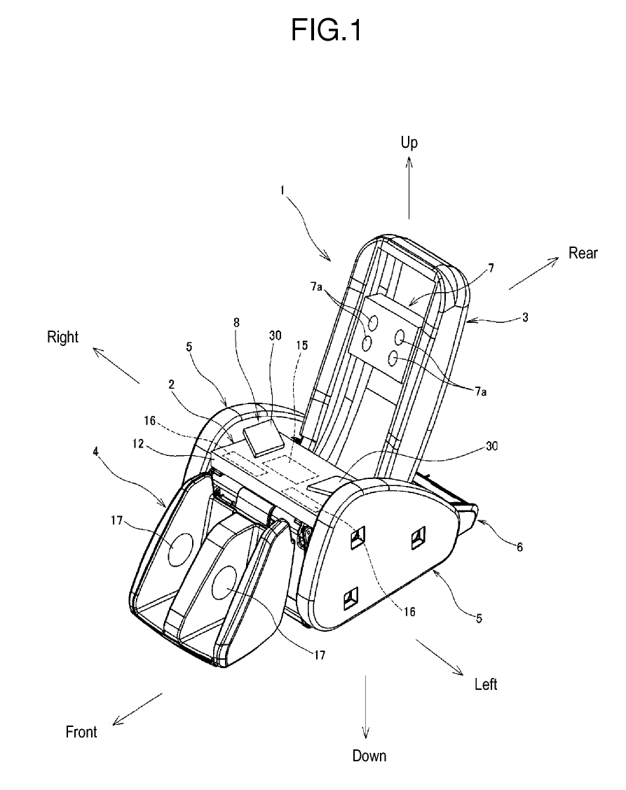

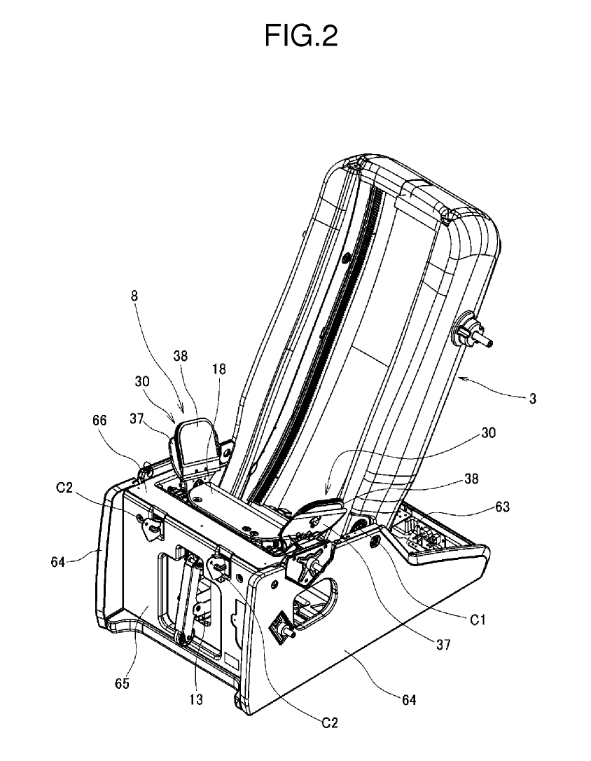

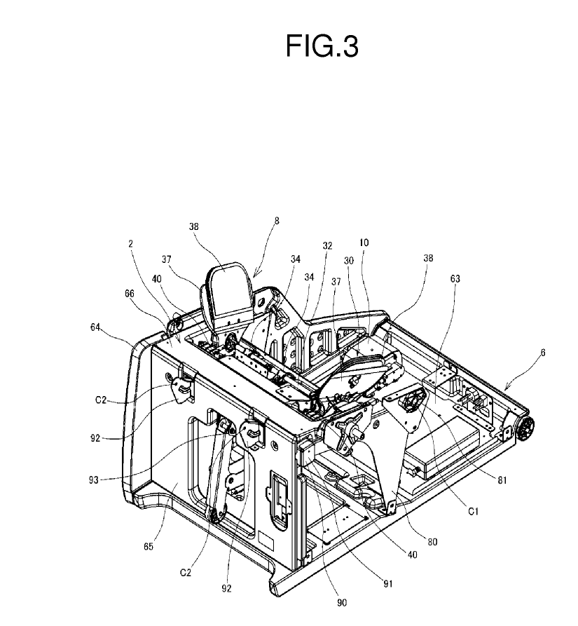

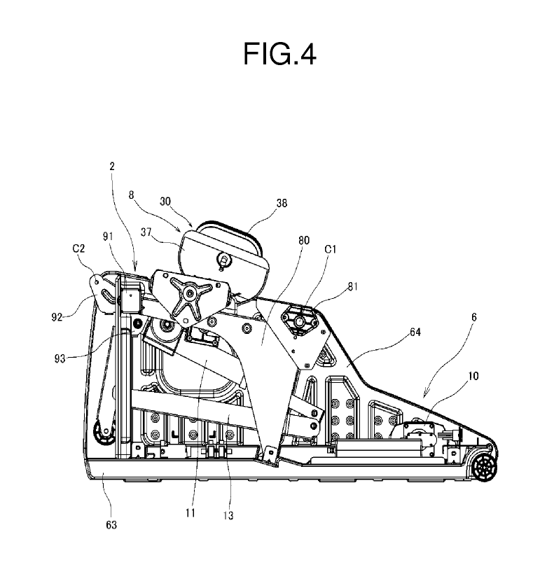

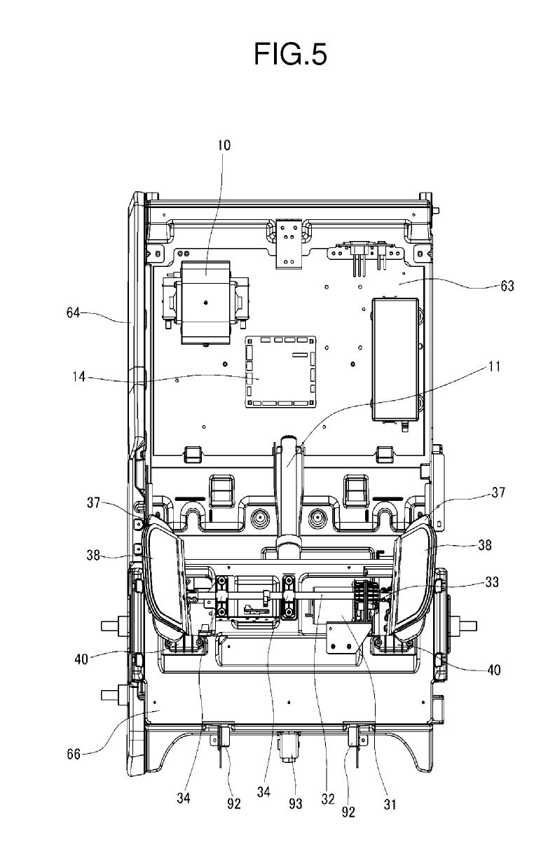

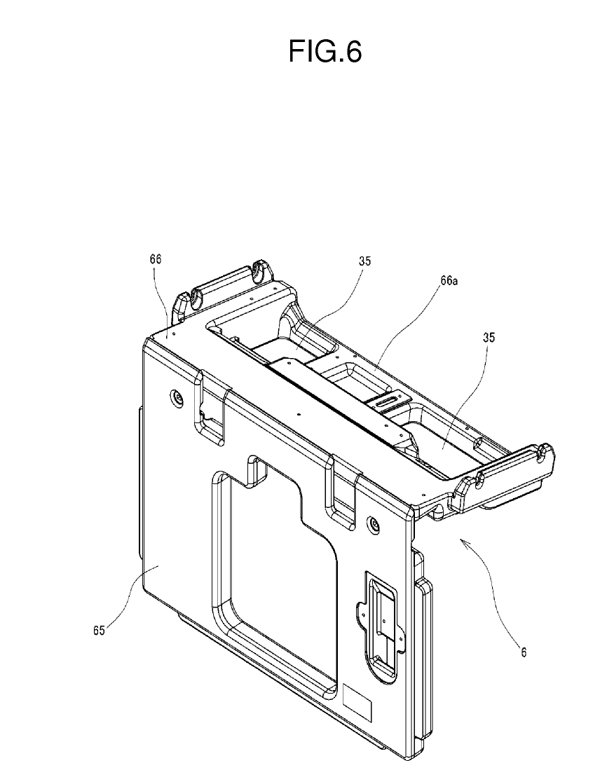

Hereinafter, a description will be given of an overall configuration of a massage machine 1 according to the present invention. FIG. 1 is a perspective view of the massage machine 1 according to an embodiment of the present invention. FIG. 2 is a perspective view of the massage machine 1, in which the inside of a seat portion 2 is exposed. FIG. 3 is a perspective view of the seat portion 2 and a leg frame 6. FIG. 4 is a side view of the seat portion 2 and the leg frame 6. FIG. 5 is a plan view of the seat portion 2 and the leg frame 6. FIG. 6 is a perspective view of the leg frame 6. In FIGS. 3 to 5, a side wall portion 64 and a cover member 18 on the left side are omitted in consideration of visibility.

In addition, directions used in the following description coincides with directions when viewed from a user who is seated on the massage machine 1 in a standing posture as shown in FIGS. 1 and 2, and descriptions will be appropriately given in other cases.

As shown in FIG. 1, the massage machine 1 according to the present invention includes a seat portion 2 on which the user is seated, a backrest portion 3, which is provided on the back side of the seat portion 2 so as to be reclined, and on which the user leans, a footrest 4 which is provided on the front side of the seat portion 2 so as to be able to swing in the vertical direction and support the legs and feet of the user, armrests 5, which are provided on both right and left sides of the seat portion 2, and on which the user place their arms, and a leg frame 6 which supports the seat portion 2 and is installed on a floor surface.

As shown in FIG. 1, a massage unit 7 as massage means which is configured to be able to move up and down along a body length direction to massage the back of the user is provided in the backrest portion 3. The massage unit 7 includes a pair of right and left treatment pieces 7a. The pair of treatment pieces 7a is moved closer to and further from each other to perform a kneading massage, and the pair of treatment pieces 7a is made to alternately advance and retreat to perform a tapping massage.

As shown in FIGS. 1 and 2, the seat portion 2 is provided with a mechanical massage mechanism 8 as massage means for massaging buttocks or thighs as treated portions. The massage mechanism 8 includes a pair of right and left treatment members 30 provided so as to correspond to outer sides of the treated portions (buttocks or thighs in the embodiment) and a detailed description will be given later. It is possible to perform a kneading operation with the treatment members 30 being operated in the horizontal direction. In addition, the seat portion 2 is provided with air cells 15 and 16 as massage means for pressing the buttocks or thighs from the lower side, and particularly, the air cells 16 for thighs are provided as a pair of right and left air cells.

As shown in FIG. 1, the footrest 4 is provided with air cells 17 as massage means for respectively massaging corresponding body parts by being made to expand and contract in accordance with air supply and air discharge. As shown in FIG. 3, the leg frame 6 is provided with an air unit 10 configured of a pump, a valve, and the like for supplying air to the air cells 15 to 17 and discharging air from the air cells 15 to 17. The air unit 10 is preferably configured so as to be able to maintain the air cells 15 to 17 in expanded states with arbitrary amounts of expansion, and in such a case, it is possible to adjust the amounts of expansion of the air cells 15 to 17.

As shown in FIG. 4, the backrest portion 3 can be reclined forward and backward about a rotation shaft C1 relative to the seat portion 2 by using a direct acting-type actuator 11 which is provided below the seat portion 2 and extends and contracts forward and backward, and the footrest 4 can swing in the vertical direction about a rotation shaft C2 relative to the seat portion 2. The backrest portion 3 and the footrest 4 are configured to move in conjunction with each other through a link member 13 and can be stopped at an arbitrary position between a standing posture (see FIG. 1) in which the backrest portion 3 stands straight and the footrest 4 is lowered and a reclined posture in which the backrest portion 3 is reclined and the footrest 4 is lifted.

As shown in FIG. 5, the massage machine 1 is provided with a control unit 14 configured of a programmable microcomputer or the like, and is configured to control the respective operations of the aforementioned massage unit 7, the massage mechanism 8, the air unit 10, and the actuator 11 in accordance with instructions from the user through an operation device (not shown) or a predetermined program.

### Configuration of Leg Frame

Hereinafter, a description will be given of a configuration of the leg frame 6. As shown in FIGS. 3 to 6, the leg frame 6 is configured of a bottom wall portion 63 which is placed on the floor surface, side wall portions 64 which are provided so as to stand from both right and left sides of the bottom wall portion 63, a front wall portion 65 which is provided so as to stand from the front portion of the bottom wall portion 63, and an upper wall portion 66 which is provided separated from the bottom wall portion 63 in the vertical direction by a predetermined distance. The respective wall portions 63 to 66 are made of resin molded into plate shapes by blow molding. In addition, a cover portion 18 (see FIG. 2) fixed to the upper wall 66 is provided so as to cover the massage mechanism 8 from the upper side. An upper surface of the cover portion 18 is formed in a substantially flat shape, and a cushion material 12 (see FIG. 1) made of urethane or the like is placed on the upper surfaces of the upper wall portion 66 and the cover portion 18. The seat portion 2 is configured of the upper wall portion 66, the cover portion 18, and the cushion material 12.

As shown in FIGS. 3 and 4, the leg frame 6 is a pair of right and left side frames 80 which supports the backrest portion 3 such that the backrest portion 3 can be reclined. The side frames 80 are members made of plate-shaped metal and are provided on a side further back than the front wall portion 65. In addition, the side frames 80 are fixed to the bottom wall portion 63, the side wall portions 64, and the front wall portion 65 by screws and the like. Moreover, the side frames 80 include bearing portions 81 provided in upper portions thereof to pivotally support the backrest portion 3.

The leg frame 6 includes an upper frame 90 provided in an upper front portion thereof to support the footrest 4 such that the footrest 4 can swing in the vertical direction. The upper frame 90 is a member made of metal and includes a coupling portion 91 which extends in the horizontal direction behind the front wall portion 65 to couple the right and left side wall portions 64, brackets 92 which are provided on both right and left ends of the coupling portion 91 to pivotally support the footrest 4, and a bracket 93 which is provided on substantially the center portion of the coupling portion 91 in the horizontal direction to pivotally support the actuator 11. The upper frame 90 is fixed to the right and left side wall portions 64 by screws and the like.

### Configuration of Massage Mechanism

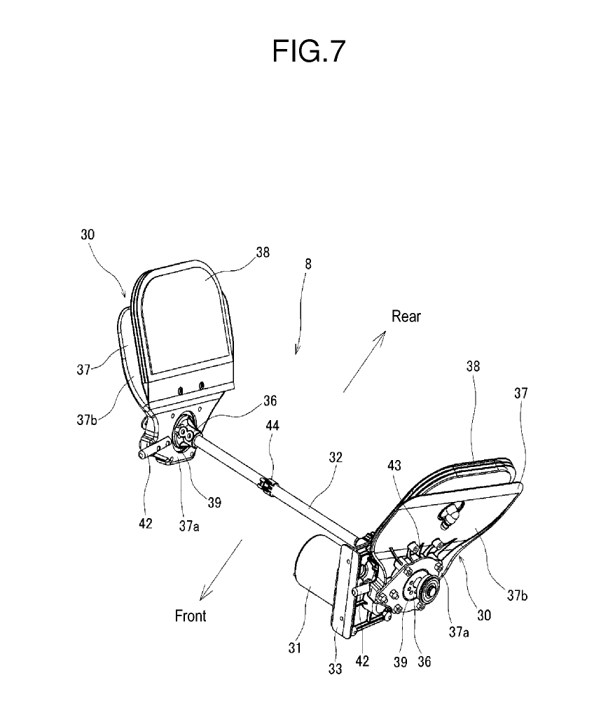

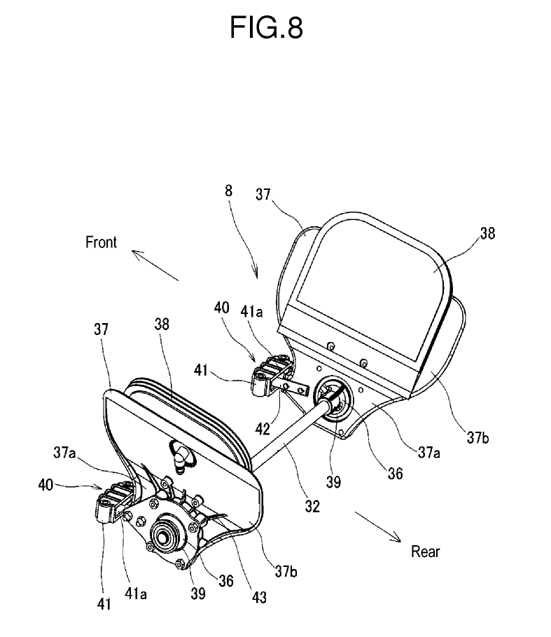

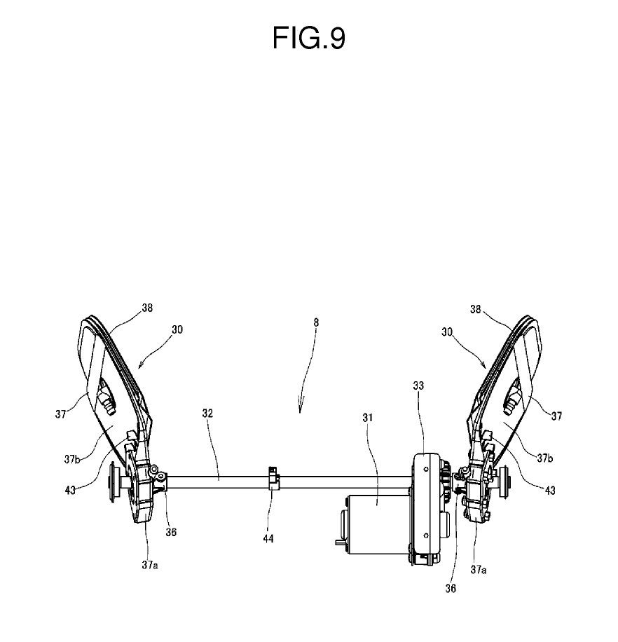

Hereinafter, a description will be given of a configuration of the massage mechanism 8. FIG. 7 is a perspective view of the massage mechanism 8. FIG. 8 is a perspective view of the massage mechanism 8 when viewed from another angle. FIG. 9 is a front view of the massage mechanism 8.

As shown in FIGS. 7 to 9, the massage mechanism 8 is configured mainly of a motor 31, a drive shaft 32 which is driven and rotated by the motor 31, and a pair of treatment members 30 which are provided on the drive shaft 32 and are arranged so as to face each other with a predetermined distance therebetween, and the massage mechanism 8 is provided in the seat portion 2. The massage mechanism 8 is attached to the upper wall portion 66 as a part of the leg frame 6. An axial direction of the drive shaft 32 corresponds to the horizontal direction, and the drive shaft 32 is coupled to the motor 31 via a decelerator 33. In addition, the drive shaft 32 is rotatably attached to a bearing portion 34 (see FIG. 5) provided in the upper wall portion 66. As shown in FIG. 6, a concave portion 66a is formed in the upper wall portion 66 in order to accommodate the massage mechanism 8 therein such that a drive mechanism of the massage mechanism 8 does not project from the seat portion 2. In addition, opening portions 35 which open in the vertical direction are provided in a location, to which the treatment members 30 correspond, in the concave portion 66a so as not to interrupt operations of the treatment members.

As shown in FIG. 9, inclined cams 36 with cam surfaces which are inclined relative to the drive shaft 32 in a front view are provided on both right and left sides of the drive shaft 32, and the inclined cams 36 are integrally rotated with the drive shaft 32. In addition, the right and left inclined cams 36 are inclined in mutually opposite directions so as to form a substantially inverted V shape in the front view. Moreover, the inclined cams 36 are provided with treatment members 30 which are arranged to face the treated portions. Each of the treatment members 30 is configured of an arm 37 which includes a plate surface in the horizontal direction and has a long dimension in the front-back direction and an air cell 38 which is provided on the inner surface of the arm 37 and expands and contracts in the horizontal direction in accordance with air supply and air discharge.

Each arm 37 is integrally configured of a coupling portion 37a which is coupled to the drive shaft 32 via the inclined cam 36 and an acting portion 37b which is formed above the coupling portion 37a and provides a massaging action on the treated portions. In addition, each arm 37 is rotatably attached to the inclined cam 36 via a bearing 39. In addition, the massage mechanism 8 is provided with guide mechanisms 40 which prevent the arms 37 from being rotated with the drive shaft 32. Each of the guide mechanism 40 is configured of a guide member 41 which is provided in the leg frame 6 and includes a long hole 41a along the horizontal direction and a guide pin 42 which is provided on each arm 37 and is inserted into the long hole 41a. The guide member 41 is provided on the front side of the arm 37, and the guide pin 42 extending toward the front side is inserted into the long hole 41a.

According to the drive shaft 32 and the pair of arms 37 coupled to the leg frame 6, motion in the vertical direction is converted into swinging motion including a horizontal component as described above if the drive shaft 32 is rotated, the front portions thereof can be moved closer to or further from each other, and the back portions thereof can be moved closer to or further from each other. Therefore, it is possible to perform a mechanical kneading operation on buttocks or thighs as treated portions. Although the guide mechanisms 40 which convert the vertical motion into the swinging motion in the horizontal direction is employed for the treatment members 30 in the embodiment, the arms 37 and the leg frame 6 may be coupled to each other with another configuration. In a case in which the arms 37 and the leg frame 6 are coupled to each other with ball joints, for example, the arms 37 can perform a three-dimensional swinging motion including components in the vertical direction, the horizontal direction, and the front-back direction.

In addition, the arms 37 are configured of a material such as nylon and can be elastically deformed in the horizontal direction. Since the coupling portions 37a are formed to have thick plate thickness and are provided with ribs 43, the coupling portions 37a have higher rigidity than that of the acting portions 37b. According to the massage mechanism 8 configured as described above, it is possible to elastically deform the arms 37 and thereby to prevent the arms 37 from being damaged when massage is performed on a user having a large body, for example, although there is a risk in that an excessive load is applied to the arms 37 during the operation of the massage mechanism 8. In contrast, since the coupling portions 37a secure rigidity, it is possible to prevent an excessive load from being applied to the drive shaft 32 and the motor 31 to which the arms 37 are coupled.

The air cells 38 are configured such that the lower sides thereof are fixed to the acting portions 37b of the arms 37 and the upper portions thereof expand in substantially fan shapes toward the inner side, and expand and contract in accordance with air supply and air discharge from the aforementioned air unit 10. If the air cells 38 configured as described above expand, it is possible to press the outer sides to upper sides of the treated portions. Furthermore, since the upper portions of the air cells 38 expand in the fan shapes toward the inner side, it is possible to reliably press the treated portion between the air cells 38 and the upper surface of the seat portion 2. In addition, the right and left air cells 38 are preferably configured so as to be able to independently expand and contract. In addition, the massage mechanism 8 is provided with a position sensor 44 which is integrally rotated with the drive shaft 32 and can detect positions of the pair of treatment members 30. Therefore, it is possible to stop the treatment members 30 at intended positions and to invert an operation direction of the treatment member 30 by inverting the motor 31 at an intended position.

### Operations of Massage Mechanism

Hereinafter, a massage operation (No. 1) of the massage mechanism 8 will be described.

The massage operation (No. 1) is a massage operation of operating only the arms 37 in the massage mechanism 8. If the drive shaft 32 is rotated by driving the motor 31, the pair of arms 37 attached to the inclined cams 36 which are inclined in the mutually opposite directions repeatedly move closer to and further from each other. More specifically, a state in which front portions of the arms 37 are located at close positions and back portions thereof are located at distant positions and a state in which the front portions of the arms 37 are located at distant positions and the back portions thereof are located at close positions are alternately repeated. By such an operation, it is possible to perform a strong mechanical kneading operation on side portions of the treated portions. Although the motor 31 may be continuously rotated in a direction, it is possible to maintain a state in which the treated portions are pinched if the motor 31 is stopped for a predetermined time during the execution of massage, and it is possible to perform a light kneading operation and to thereby enhance a massage effect by changing the rotation direction of the motor 31.

Hereinafter, a massage operation (No. 2) of the massage mechanism 8 will be described.

The massage operation (No. 2) is a massage operation of operating the arms 37 and the air cells 38 in the massage mechanism 8. If the drive shaft 32 is rotated by driving the motor 31, the pair of arms 37 attached to the inclined cams 36 which are inclined in the mutually opposite directions repeatedly move closer to and further from each other. More specifically, the state in which the front portions of the arms 37 are located at close positions and the back portions thereof are located at distant positions and the state in which the front portions of the arms 37 are located at distant positions and the back portions thereof are located at close positions are alternately repeated. Furthermore, if the air unit 10 is driven, the air cells 38 repeat expansion and contraction. By such operations, it is possible to perform a strong mechanical kneading operation on the side portions of the treated portions and a soft air kneading operation on portions from the side portions to the upper portions of the treated portions in the composite manner.

The expansion and the contraction of the air cells 38 may be repeated while the arms 37 are made to repeatedly move closer to and further from each other, or alternatively, the motor 31 may be stopped for a predetermined time in a state in which the pair of arms 37 are made to pinch the treated portions, and the kneading operation using the air cells 38 may be performed. Alternatively, the arms 37 may be made to repeatedly move closer to and further from each other while the air cells 38 are maintained in the expanded state. It is possible to swing the body in the horizontal direction by causing the right and left air cells 38 to alternately expand, and it is possible to perform the kneading operation while swinging the body if the motor 31 is further driven. As described above, it is possible to perform various kinds of massage as compared with the massage operation (No. 1).

Hereinafter, a massage operation (No. 3) of the massage mechanism 8 will be described.

The massage operation (No. 3) is a massage operation of operating the arms 37 by the massage mechanism 8 while the air cells 38 are adjusted to the expanded state of a desired amount of expansion. For example, the user operates the operation device (not shown) to adjust the expanding amount of the air cells 38 as desired. Then, if the motor 31 is driven and the drive shaft 32 is rotated, the pair of arms 37 attached to the inclined cams 36 which are inclined in the mutually opposite directions are made to repeatedly move closer to and further from each other. More specifically, the state in which the front portions of the arms 37 are located at close positions and the back portions thereof are located at distant positions and the state in which the front portions of the arms 37 are located distant positions and the back portions thereof are located at close positions are alternately repeated. By such operations, it is possible to perform the mechanical kneading operation with the strength that the user desires. In addition, it is possible to change the interval between the pair of treatment members 30 and to thereby perform satisfactory massage on users with different body shapes. In addition, it is needless to say that the operation of the motor 31 can be controlled in the same manner as in the massage operation (No. 1).

Hereinafter, a massage operation (No. 4) will be described.

The massage operation (No. 4) is a massage operation as a combination of an operation of the massage mechanism 8 and operations of the air cells 15 and 16 provided on the upper surface of the seat portion 2. Since positions (heights) of the treated portions relative to the massage mechanism 8 vary if the operations of the air cells 15 and 16 on the upper surface of the seat portion 2 and the operation of the massage mechanism 8 are combined, for example, it is possible to change portions treated by the massage mechanism 8. Alternatively, if the motor 31 is driven while the air cells 15 and 16 on the upper surface of the seat portion 2 and the air cells 38 provided on the arms 37 are maintained in the expanded state, it is possible to perform the mechanical kneading operation on the treated portions while the treated portions are pinched by the air cells 15, 16, and 38. In addition, it is needless to say that the operation of the motor 31 can be controlled in the same manner as in the massage operation (No. 1).

Hereinafter, a massage operation (No. 5) will be described.

The massage operation (No. 5) is a massage operation as a combination of an operation of the massage mechanism 8 and a reclining operation of the backrest portion 3. If the actuator 11 is driven to recline the backrest portion 3, for example, the positions of the treated portions relative to the massage mechanism 8 vary. Specifically, the user moves to a head side in response to the reclining of the backrest portion 3 to the back side, and the position of the massage mechanism 8 relative to the user moves to the thigh side as compared with that in the standing posture. As described above, it is possible to change the treated portions without changing the position of the massage mechanism 8 in the body length direction. If the motor 31 or the air unit 10 is driven to recline the backrest portion 3 in a state in which the treated portions are pinched by the pair of treatment members 30, it is possible to cause the treatment members 30 which are located at close positions to dig into the treated portions and to thereby provide strong stimulation. In addition, it is needless to say that the operation of the motor 31 can be controlled in the same manner as in the massage operation (No. 1).

### Configuration of Massage Machine According to Another Embodiment

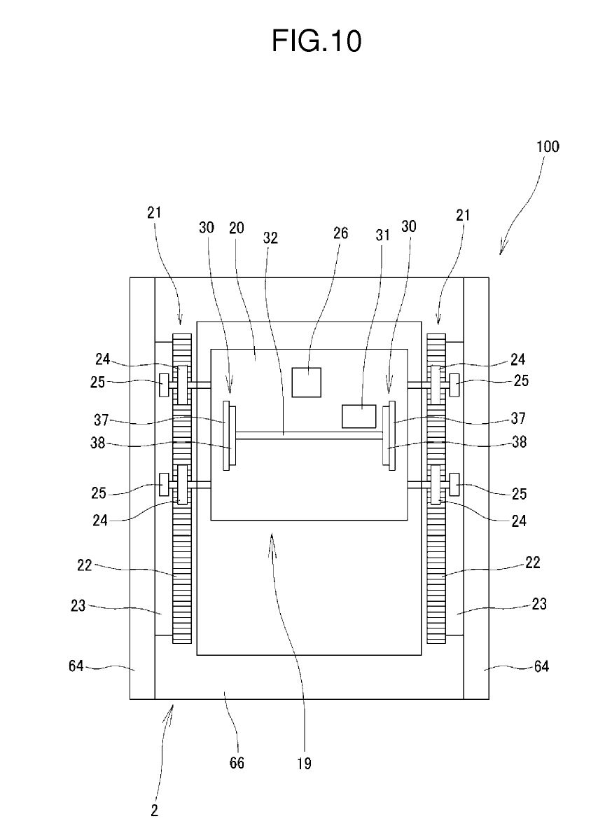

Hereinafter, a description will be given of a massage machine 100 according to another embodiment of the present invention. FIG. 10 is a plan view of a seat portion 2 in the massage machine 100 according to another embodiment of the present invention.

In addition, the massage machine 100 according to another embodiment is essentially different from the massage machine 1 according to the aforementioned embodiment in that the massage machine 100 includes a moving mechanism 21 capable of moving the massage mechanism 19 in the body length direction. Since the other configurations are the same as those in the massage machine 1, the same reference numerals are provided below, and the descriptions thereof will be omitted.

According to the massage machine 100 of the embodiment, the massage mechanism 19 is configured to be able to move in the body length direction. The massage mechanism 19 is configured mainly of a base frame 20, a motor 31, a drive shaft 32 which is driven and rotated by the motor 31, and a pair of treatment members 30 which are provided on the drive shaft 32 and are arranged so as to face each other with a predetermined distance therebetween, and the massage mechanism 19 is provided in the seat portion 2. In addition, the moving mechanism 21 which moves the massage mechanism 19 in the body length direction is also provided. Although the massage mechanism 19 is configured to move the seat portion 2 in the embodiment, another configuration is also applicable in which the backrest portion 3 or the footrest 4 is moved, or still another configuration in which at least two from among the backrest portion 3, the seat portion 2, and the footrest 4 are moved.

The moving mechanism 21 is configured of racks 22 and guide rails 23 which are provided in the leg frame 6 so as to extend in the body length direction of the seat portion 2 and guide rollers 25 which are provided on both sides of the massage mechanism 19 and turn pinions 24 engaging the racks 22 and the guide rails 23. The racks 22 and the guide rails 23 are provided in the side wall portions 64 or the upper wall portion 66, and a motor 26 for rotating the pinions 24 are preferably provided in the massage mechanism 19. With such a configuration, it is possible to adjust the position of the massage mechanism 19 in the body length direction. If the message mechanism is moved in the body length direction while the massage mechanism 19 is made to operate, it is possible to perform the kneading operation while rubbing the treated portions and to thereby enhance massage effects.

The present invention can be applied to a massage machine capable of performing various kinds of massage and performing massage which can satisfy users with different body shapes.

Although the invention has been described in terms of exemplary embodiments, it is not limited thereto. It should be appreciated that variations may be made in the described embodiments by persons skilled in the art without departing from the scope of the invention as defined by the following claims. The limitations in the claims are to be interpreted broadly based on the language employed in the claims and not limited to examples described in this specification or during the prosecution of the application, and the examples are to be construed as non-exclusive. For example, in this disclosure, the term “preferably”, “preferred” or the like is non-exclusive and means “preferably”, but not limited to. The use of the terms first, second, etc. do not denote any order or importance, but rather the terms first, second, etc. are used to distinguish one element from another. The term “substantially” and its variations are defined as being largely but not necessarily wholly what is specified as understood by one of ordinary skill in the art. The term “about” or “approximately” as used herein can allow for a degree of variability in a value or range. Moreover, no element or component in this disclosure is intended to be dedicated to the public regardless of whether the element or component is explicitly recited in the following claims.

What is claimed is:

1. A massage machine comprising:
a massage mechanism; an air unit; and a control unit;
wherein the massage mechanism comprises:
a motor;
a drive shaft wherein the motor drives the drive shaft; and
a pair of treatment members that comprise: a pair of arms supported by the drive shaft and is moved closer to and further from each other by the drive shaft; and air cells that are provided on inner side surfaces of the arms, the air cells face each other, expand and contract in accordance with air supply and air discharge;
the air unit is configured to supply the air to the air cells and discharge the air from the air cells; and
the control unit is configured to control the motor and the air unit.

2. The massage machine according to claim 1, further comprising:
a seat portion, wherein the massage mechanism is provided in the seat portion.

3. The massage machine according to claim 1,
wherein the control unit controls the driving of the motor and the air unit so as to cause the air cells to expand and contract while moving the pair of arms closer to and further from each other.

4. The massage machine according to claim 1,
wherein the control unit is configured to control the driving of the motor and the air unit so as to move the pair of arms closer to and further from each other when the air cells are expand.

5. The massage machine according to claim 1,
wherein the control unit is configured to control the air unit to adjust an amount of expansion of the air cells.

6. The massage machine according to claim 1,
wherein the arms are configured to be elastically deformed in an arms' facing direction.

7. The massage machine according to claim 6,
wherein the arms comprise acting portions that provide a massage action, and coupling portions that are coupled to the drive shaft, and
wherein the coupling portions have an rigidity that is higher than an rigidity of the acting portions.
